(19) United States
(12) Patent Application Publication
(10) Pub. No.: US 2003/0021016 A1
(43) Pub. Date: Jan. 30, 2003

(54) Parallel scanned laser confocal microscope

(76) Inventor: David G. Grier, Chicago, IL (US)

Correspondence Address: Michael D. Rechtin, Foley & Lardner, Suite 3300, 330 North Wabash Avenue, Chicago, IL, 60611-3608, US

(21) Appl. No.: 09/917,346

(22) Filed: Jul. 27, 2001

(51) Int. Cl. G02B 21/00

(52) U.S. Cl. 359/368; 359/558

(57) ABSTRACT

A confocal microscope system for examination of a sample, comprising a source for a laser beam, a diffraction medium which interacts with the laser beam to produce a plurality of laser beams, and an optical component to apply the plurality of laser beams to the sample. The multiple laser beams operate in parallel and in conjunction with a spatially-resolved area detector to receive the optical images created by each of the beams, resulting in an increased acquisition rate, a compact design and other benefits.

This invention was made with U.S. Government support under Grant No. DMR-9730189 awarded by the National Science Foundation and through the MRSEC Program of the National Science Foundation under Grant Number DMR-9880595.

The present invention is directed generally to a method and apparatus for creating three-dimensional images of samples using principles of scanned laser confocal microscopy. More particularly, the invention is directed to a method and apparatus for the use of multiple scanned laser beams operating in parallel and in conjunction with a spatially-resolved area detector to receive the optical images created by each of the plurality of beams. This method and apparatus retains all of the advantages of conventional scanned laser confocal microscopy with the substantial additional advantages of (1) greatly increased acquisition speed, (2) the longest possible exposure times for samples which produce low-light-level images, (3) compact design, (4) no moving parts, and (5) the feature of integrated optical trapping with no additional components.

It is known that confocal microscopy can be applied using a tightly focused beam of light to illuminate a sample. The illumination is most intense at the focal point, so that the volume of the sample located at the focal point has more opportunity to scatter the incident light than any other region of the sample. The light detection system in a confocal microscope also is focused onto the same volume of the sample as the illumination system. Light scattered by the sample from this volume thus is preferentially detected relative to light scattered by other regions of the sample. The detection system's selectivity for light scattered within the illuminated volume typically is enhanced by the addition of one or more apertures which block light emanating from other regions of the sample.

The combination of selective illumination with a focused light source and selective detection with an optical system focused onto the same sample volume (confocal detection) provide a conventional confocal microscope with several capabilities. The confocal detection system's ability to reject light scattered from other regions of the sample makes possible imaging in relatively turbid samples. Confocal imaging with high numerical aperture optics also makes possible imaging with very small depth of focus. Confocal microscopes thus can focus deep into samples and create well-resolved optical slices through a three-dimensional sample with minimal cross-talk or convolution of images between slices. These optical slices then can be combined to create a three-dimensional representation of the sample.

The principal practical considerations for establishing confocal microscopy are (1) to scan the focused illumination through the sample in a desired pattern and (2) to maintain confocal detection by keeping the focal volume aligned with the illumination volume. A typical conventional implementation of laser scanning confocal microscopy 128 is shown in FIG. 1. A collimated laser beam 100 passes through a beam splitter 110 before being deflected by a gimbal-mounted mirror 114, or equivalent beam steering device. This beam is directed into the back aperture of the microscope's objective lens 125 through a relay lens consisting of lenses 115 and 116 and beam splitter 120. Typically, an objective lens 125 and the beam splitter 120 are included in the body of the conventional optical microscope 128 and the additional components are mounted outside the microscope's body as a separate assembly. The laser beam 100 is focused to a point 140 by the objective lens 125 to illuminate a sample 142, and 144 light is scattered by the sample 142, and light 144 radiates in all directions. Some fraction of this scattered light 144 falls within the acceptance solid angle of the objective lens 125 and travels backwards down the beam line followed by the illumination light 100. This fraction is labeled 101 in FIG. 1 and is shown superimposed on the illuminating beam 100. The returned beam 101 emanates from the focal point 140 of the objective lens and so is collimated by the objective lens. Light originating from other sources (not shown in FIG. 1) is not collimated by the objective lens. In practice, both the illuminating 100 and returned 101 beams would fill the entire aperture of the optical train. The returned beam 101 is reflected by the gimbal mounted mirror 114 back along the path taken by the illuminating laser 100 and then reflected again by beam splitter 110. The collimated returned beam passes through aperture 118 and is detected by photodetector 119. Rays of light emanating from a source not located at the focus 140 would not pass through aperture 118 and so would not be detected.

Tilting the gimbal-mounted mirror 114 deflects the illuminating beam 100 and so translates the focal spot 140 across the microscope's field of view. Because the returned beam 101 follows the same optical path as the illuminating beam, up to the beam splitter 110, the detection system is confocal with the illumination system. Scanning the focal spot 140 across the field of view with the gimbal-mounted mirror 114 and correlating the signal measured with the photodetector 119 with the mirror's deflection angle yields a two-dimensional optical slice through the sample 142.

The beam splitters 110 can be selected to optimize illumination and detection efficiency. If the returned beam has the same wavelength as the illumination beam, efficiency could be improved by using a polarization selective form of the beam splitter 110 and adding polarization-rotating components in the beam line. If the returned beam has a different wavelength because it results from fluorescence, for example, then selection could be based on wavelength, using a dichroic form of the beam splitter 110.

The rate at which such an optical slice can be obtained is limited by the rate at which the beam can be deflected by mirror 114. A mechanical deflector, such as a gimbal-mounted form of the mirror 114, offers a relatively slow deflection rate, with a bandwidth typically well below 1 kHz. Acousto-optical and electro-optical deflectors offer much higher bandwidths but introduce aberrations into both the illuminating and returned beams whose severity varies with the deflection angle. Increasing the deflection rate to increase the imaging rate has the undesirable consequence of reducing the length of time that the illuminating beam is focused on any particular region of the sample. Imaging weakly scattering samples therefore, is hampered by low light levels (and thus low contrast) at the detector 119. A number of disadvantages therefore exist for a conventional single beam confocal microscopy system.

### SUMMARY OF THE INVENTION

Parallel laser scanning confocal microscopy uses a plurality of laser beams to scan through a sample simultaneously, and a pixellated area detector is preferably used to detect separately the light scattered by each of the plural laser beams. Scanning a plurality of laser beams through the sample simultaneously provides several advantages over conventional single-beam scanning laser confocal microscopy. For equal scanning rates, parallel scanning reduces the total data acquisition time for one slice by a factor equal to the number of beams. This can be useful for high-speed imaging of moving samples. Further improvements in simultaneous imaging accrue from having many beams probe many regions of the sample simultaneously. Single-beam systems, by contrast, expose one volume element at a time, so that the last volume element is imaged one entire scan period after the first volume element.

For equal acquisition times, parallel scanning increases the illumination period for each volume of the sample by a factor equal to the number of beams. This can be extremely useful for weakly-scattering samples by permitting much longer exposure times without increasing the time to acquire a complete image. Furthermore, delicate samples can be imaged in proportionately lower light levels, thereby reducing the possibility of damage by laser irradiation.

Other important advantages are that parallel laser scanning confocal microscopy can be implemented with fewer optical components and without moving parts. The simplified optical train can be aligned simply and precise alignment can be obtained automatically under software control, thereby relaxing the specifications on alignment and alignment stability during manufacturing.

It is therefore an object of the invention to provide an improved method and system for confocal microscopy.

It is another object of the invention to provide an improved method and system for plural beam laser scanning microscopy.

It is a further object of the invention to provide an improved method and system for parallel laser beam scanning confocal microscopy.

It is an additional object to provide an improved method and system for plural laser beam scanning of weakly scattering and light sensitive samples for enhanced image formation without sample damage.

Other objects, advantages and features of the present invention will be readily apparent from the following description of the preferred embodiments taken in conjunction with the accompanying drawings described hereinafter.

### BRIEF DESCRIPTION OF THE DRAWINGS

FIG. 1 illustrates a conventional laser scanned confocal microscopy system;

FIG. 2 illustrates one embodiment of a confocal microscopy system of the invention;

FIG. 3 illustrates optical system rejection characteristic of the system of FIG. 2; and

FIG. 4 illustrates another embodiment of a confocal microscopy system of the invention.

### DETAILED DESCRIPTION OF THE PREFERRED EMBODIMENTS

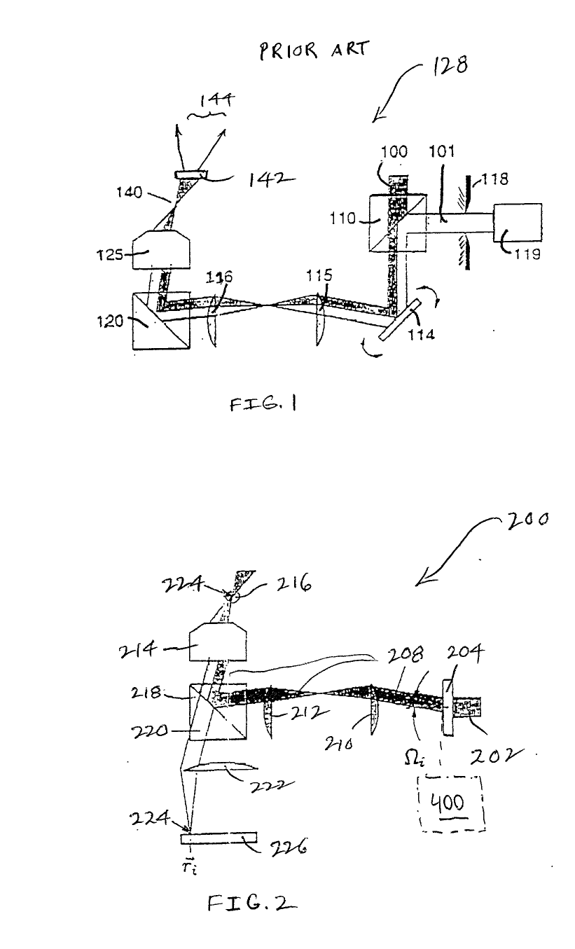

One embodiment of a parallel laser scanning confocal microscope is shown generally at 200 in FIG. 2. A collimated laser beam 202 is incident on a diffractive medium, such as a diffractive beam splitter 204 which divides the beam 202 into N separate collimated beams, only one beam 208 of which is shown in FIG. 2 for clarity. Each of the diffracted beams 208 emanates from the diffractive beam splitter 204 at a distinct direction denoted by the solid angle Ω. The number N of the beams 208, their relative intensities, and their angular configuration Ω, all are most preferably determined by a computer-generated hologram encoded in the diffractive beam splitter 204. This diffractive beam splitter 204 can be implemented with a variety of media including addressable liquid crystal phase shifting arrays, microelectromechanical (MEMS) micromirror arrays, or diffractive optical elements encoded in the surface relief or dielectric constant of otherwise transparent substrates, or encoded in the surface of reflective surfaces. Such systems are represented as 400 in FIG. 2.

Each of the diffracted beams 208 is transferred by a relay lens system, one embodiment of which includes a first lens 210 and a second lens 212, also shown in FIG. 2. The lenses 210 and 212, or equivalent optical elements, are arranged so that a collimated beam of light, such as 208, emerging from the center of the diffractive beam splitter 204 also passes as a collimated beam 208 through the center of the entrance pupil of focusing element 214. In a preferred embodiment, this focusing element 214 consists of a high-numerical aperture objective lens. In the implementation depicted in FIG. 2, the beams 208 are reflected into the back aperture of the focusing element 214 by a beam splitter 204 whose reflective properties are chosen to direct the illuminating laser light towards the focusing element. Each collimated one of the beams 208 enters the back aperture of the objective lens (the focusing element 214) at a distinct angle which is proportional to the angle Ω, which is established by the diffractive beam splitter 204. Thus, each of the beams 208 comes to a separate focus in the focal plane of the objective lens 214 at a displacement from the center of the field of view proportional to Ω. By controlling the number N and direction Ω of the beams 208 created from the collimated laser beam 202, the diffractive beam splitter 204 controls the pattern and location of focused spots of laser light in its object plane. The particular focal spot for the beam 208 is indicated at 224 in FIG. 2.

Some of the light from the beam 208 focused at a focal point 224 will be scattered by sample 216 at that focal point 224. This light component emanates as if from a point source in the focal plane of the objective lens 214 and will be collimated thereby, returning down the optical path initially taken by the illuminating collimated beam 208. Rather than allowing this returned light to travel all the way down the illumination path, as shown in the prior art system of FIG. 1, the second beam splitter 218 allows a returned beam 220 to pass through to the microscope's imaging optics, represented schematically by an ocular lens 222 in FIG. 2. The returned beam 220 is shown superimposed on the collimated beam 208 for clarity. In practice, both the beams 208 and 220 would fill the aperture of the objective lens 214.

Each of the collimated beams 208 created by the diffractive beam splitter 204 illuminates a separate volume of the sample 216 and thus results in a separate returned beam, such as the returned beam 220 resulting from one of the collimated beams 208. The intensity of each of these returned beams 220 depends on the efficiency with which each region of the sample 216 scatters laser light. Each of the returned beams 220 is brought to a separate focus by the ocular lens 222, with only the particular focus for the returned beam 220 being shown in FIG. 2 for clarity, with the focal point being indicated at 224.

The individually focused beams of light from the returned beams 220 can be detected simultaneously with a pixellated area detector 226, such as a charge-coupled device (CCD) camera or other numerous conventional area sensor technologies available to detect light at selected locations. These technologies include but are not limited to photodetector arrays, microchannel plates, and complementary metal-oxide-semiconductor (CMOS) detectors. The location \vec{r}, of one of the particular returned beams 220 on the detector 226 depends on the direction Ω at which the collimated beam 208 was created by the diffractive beam splitter 204. The angular range Ω can be selected so that \vec{r} coincides with one of the pixels on the area detector 226 for each of the N illuminating collimated beams 208. This alignment can be obtained by calculating approximately the phase shifting pattern projected by the beam splitter 204 and can be considered as virtual alignment. Virtual alignment can be obtained under software control by imaging a uniformly reflective surface and calculating holograms which project spots centered on pixels located in the area detector 226.

If the computer-generated diffractive beam splitter 204 is implemented in the form of an addressable device, such as a spatial light modulator, then the beam configuration can be updated with a new pattern, thereby addressing a new set of sample volumes whose images will be projected onto a new set of pixels on the area detector 226. In this way, one optical slice of the sample 216 can be scanned by updating the diffractive beam splitter 204 with a sequence of complementary patterns.

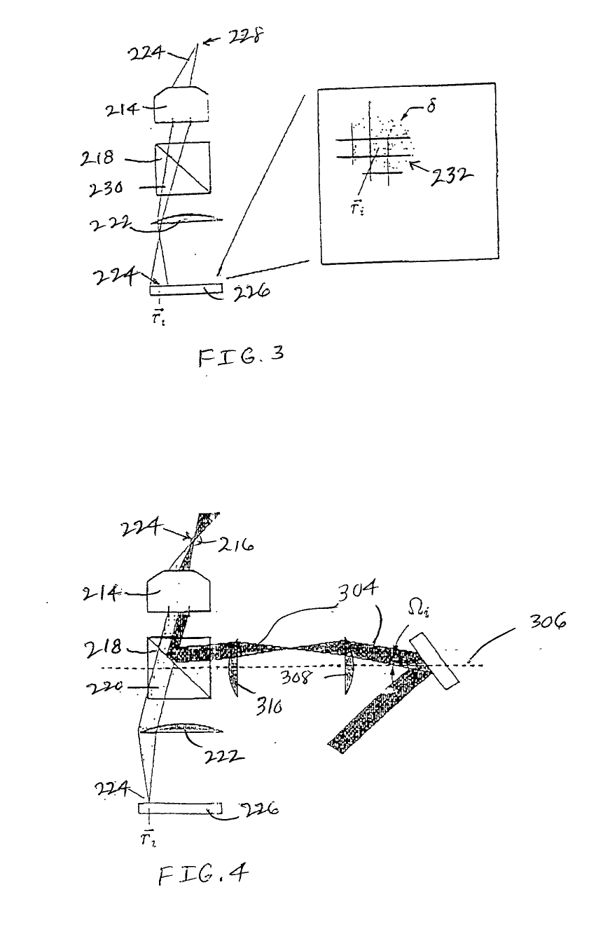

Furthermore, the embodiment of the invention in FIG. 2 indicates that beam splitter 204 operates in a transmission mode. The same basic scheme will operate also with a reflective diffractive form of the beam splitter 204, with appropriate modifications being made in the optical train. One form of this embodiment will be described hereinafter as shown in FIG. 4 as one example of the reflective mode of operation.

Another advantage of the microscope 200 as depicted in FIG. 2 is the lack of any apertures, unlike the prior art design in FIG. 1. Although there are no apertures, the microscope 200 still achieves excellent confocal imaging. Consider a region of the sample 216 near, but not at the confocally illuminated volume disposed about the focal point 224 in FIG. 2. An example of such a location is denoted as region 228 in FIG. 3. Some of the light scattered by this region 228 will be collected by the objective lens 214. However, because this source of light (the region 228) does not lie in the objective's focal plane, the returned light 230 is not collimated. Rather than being brought to a focus by the ocular lens 222 onto the area detector 226, the returned light 230 is defocused. This diffuse scattering pattern, labeled as zone 232 in FIG. 3, delivers much less light to the pixel at \vec{r} than would an equivalent element of the sample 216 at the confocal focal point 224. This intensity reduction comes from two sources. In the first case, the illumination is far less intense away from any of the confocal points, than it is at the confocal focal point 224. Thus, there is less light to scatter at non-confocal points. In fact, the sources of detectable image light must come from the intensely illuminated regions near the confocal points. The returned fraction of the non-confocal scattering then is further reduced in intensity by being spread across several detector pixels of the area detector 226 other than the confocally illuminated pixel at position \vec{r}.

Each confocally illuminated pixel of the area detector 226 therefore is surrounded by a “zone of confusion” (the zone 232) of approximate radius 6 within which non-confocal regions of the sample 216 contribute to the detected signal. This light would be filtered out in a standard confocal optical train such as in the prior art embodiment of FIG. 1 by an aperture 118. This light can be rejected in the microscope 200 by ignoring the data generated by pixels in the zone 232 around each confocally illuminated pixel of the area detector 226. Rejecting signals from non-confocally-illuminated pixels performs the task normally performed by an aperture 118 and thus can be functionally considered a virtual or synthetic aperture.

If the beam splitter 204 of FIG. 2 produces the collimated beams 208 whose images were closer than δ on the area detector 226, then non-confocal scattering from each would be detected by the others, thereby degrading performance. The pattern of the beams 208 created by the beam splitter 204 therefore is most preferably chosen so that no two images are closer than δ at the area detector 226. Minimizing crosstalk between simultaneously illuminated pixels of the area detector 226 in this manner sets the maximum number N of spots which can be used to illuminate the sample 216 in any configuration. If the area detector 226 has M pixels, then N≈M/(4δ²).

It should be noted that the confocal microscope 200 can also be adapted to function in an optical tweezer mode. This additional use can be accomplished by increasing the intensity of light to one of the illuminating collimated beams 208 enabling function as an optical tweezer. Varying the intensity of one or more beams relative to the others can be accomplished by computing and projecting an appropriate diffraction pattern in which the desired trapping beams receive a greater proportion of the light available in the beam 202. This operation can be performed in tandem with varying the power of the laser beam 202 so as to maintain constant imaging intensity during trapping. This optical tweezer mode of the microscope 200 also could operate to provide a converging or diverging light beam 208 which would be brought to a focus on form an optical trap out of the focal plane of the objective lens 214, provided an appropriate hologram were computed, and thus the light scattered by the trapped portion of the sample need not be detected by the confocal detection scheme, unless so desired.

In yet another example form of the invention shown in FIG. 4 a parallel scanned confocal microscopy system 300 employs a reflection-mode spatial light modulator 302. A beam of light 304 is incident on the face of the spatial light modulator 302 (hereinafter SLM 302). The SLM 302 encodes a phase modulation on the beam of light 304 suitable for splitting the beam of light 304 into several independent beams, only one of which 304 is shown for clarity. Each of the beams of light 304 is directed by the same phase pattern into a distinct direction, with the depicted collimated beam 304 being directed at solid angle Q away from an optical axis 306. Each of the collimated beams 304 created and directed by the phase pattern of the SLM 302 is transferred to the back aperture of the objective lens 214 (or other suitable focusing optical element) to create the diffraction limited focal point 224. In FIG. 1 the collimated beams 304 are transferred with two lenses 308 and 310 arranged to create a plane conjugate to the objective's back aperture at the center of the SLM 302. The optical axis 306 is thus established so that a beam of light passing from the SLM 302 along the optical axis 306 will pass through the center of the objective's back aperture and come to a focus in the middle of the objective's focal plane. A beam such as the collimated beam 304 traveling at an angle of Ω with respect to this optical axis 306 passes through the middle of the back aperture at an angle and thus forms the focal point 224 away from the center of the focal plane. The beam splitter 218 serves to direct the collimated beams 304 into the aperture of the objective lens 214.

Any material at the focal point 224 can scatter some of the incident light out of the focal point 224. Some of this scattered light can be collected by the objective lens 214 to form a returned beam 220 The second beam splitter 218 can be selected to transfer some or all of this returned beam 220 to the imaging microscopy system 300 and the area detector 226. Light emanating from the focal point 224 is focused by the ocular lens 222 into a spot on the area detector 226 centered at position 312. This position 312, in turn, depends on the angle Ω that the illuminating collimated beam 304 makes with the optical axis 306. This, in turn depends on the phase pattern encoded in the SLM 302.

In regard to resolution of positioning the collimated beam of light 304, a typical form of the SLM 302, has a square or rectangular array of phase-shifting pixels, each of which typically covers a square or rectangular region of the SLM's active aperture. If the SLM 302 has N pixels in one dimension, and each pixel can implement p levels of phase shift, ranging between 0 and 2π radians, then the SLM 302 can steer a bean into 2Np directions along that dimension. The actual angular deflection depends on the separation between pixels a and the wavelength of light λ, with the increment between angular deflections being λ/(Npa) in the paraxial approximation. The same result obtains for the SLM 302 or diffractive beam splitter 204 operating in reflective or transmissive mode.

The resolution with which the collimated beams 304 directed by the SLM 302 can be positioned on the area detector 226 depends on the magnification of the microscopy system 300, shown schematically as the simple ocular lens 222 in FIG. 4, and on the number M of detector pixels in a given dimension. The optimal magnification matches the scan range obtained from the SLM 302 with the active area of the area detector 226. In this condition, an individual one of the collimated beams 304 can be placed to within M/(Np) of the center of an imaging pixel. Alignment accuracy approaching 1/10 pixel therefore can be obtained over a typical 512×512 imaging area using commercially available ones of the SLM 302.

While preferred embodiments of the invention have been shown and described, it will be clear to those skilled in the art that various changes and modifications can be made without departing from the invention in its broader aspects as set forth in the claims provided hereinafter.

What is claimed is:

1. A confocal microscope system for examination of a sample, comprising:
a source for a laser beam;
a diffraction medium which interacts with the laser beam to produce a plurality of laser beams; and
an optical component to apply the plurality of laser beams to the sample.

2. The confocal microscope system as defined in claim 1 further including a detector to sense light beams scattered from the sample.

3. The confocal microscope system as defined in claim 2 wherein the detector comprises a pixellated area detector.

4. The confocal microscope system as defined in claim 2 wherein the detector comprises a position-sensitive image-forming photodetector.

5. The confocal microscope system as defined in claim 4, wherein the position-sensitive image-forming photodetector comprises a charge coupled device.

6. The confocal microscope system as defined in claim 4, wherein the position-sensitive image-forming photodetector comprises a complementary metal-oxide-semiconductor detector.

7. The confocal microscope system as defined in claim 4, wherein the position-sensitive image-forming photodetector comprises a photodetector array.

8. The confocal microscope system as defined in claim 4, wherein the position-sensitive image-forming photodetector comprises a microchannel plate.

9. The confocal microscope system as defined in claim 1 wherein the plurality of laser beams arising from the diffraction medium are generated to interact simultaneously with a plurality of sample volumes.

10. The confocal microscope system as defined in claim 1 wherein the diffraction medium comprises a holographic element.

11. The confocal microscope system as defined in claim 1 further including a relay lens disposed downstream from the diffraction medium.

12. The confocal microscope system as defined in claim 11 further including a beam splitter and an objective lens receiving a laser beam from the beam splitter.

13. The confocal microscope system as defined in claim 12 wherein the beam splitter operates to pass light reflected from the sample and enables the light to strike an area detector.

14. The confocal microscope system as defined in claim 13 further including an ocular lens disposed between the beam splitter and the area detector.

15. The confocal microscope system as defined in claim 2 further including computer software executable for establishing virtual alignment of the plurality of laser beams at positions on the detector.

16. The confocal microscope system as defined in claim 15 wherein the virtual alignment includes calculating a phase shifting pattern implemented by the diffraction medium.

17. The confocal microscope system as defined in claim 15 wherein a uniformly reflective surface is imaged by using the computer software and a computer calculates a hologram which projects light spots on selected pixels of the detector.

18. The confocal microscope system as defined in claim 1 wherein the diffraction medium comprises an addressable spatial light modulator, thereby enabling dynamic change of sample volumes undergoing illumination by the plurality of laser beams.

19. The confocal microscope system as defined in claim 18 wherein the spatial light modulator is programmed to cause scanning of a selected area slice of the sample.

20. The confocal microscope system as defined in claim 15 wherein the computer software operates to reject sensed light signals arising from a zone of confusion around a confocal region of interest in the sample.

21. The confocal microscope system as defined in claim 1 further including computer software executable to select at least one of the plurality of laser beams to increase its light intensity and use the at least one laser beam as an optical tweezer.

22. The confocal microscope system as defined in claim 1 wherein the diffraction medium comprises a reflection-mode spatial light modulator.

23. A method of performing confocal microscopy on a sample, comprising the steps of:
providing a laser beam;
applying the laser beam to a diffraction medium having a preselected diffractive pattern;
outputting a plurality of diffracted laser beams from the diffraction medium, the diffracted laser beams having their spatial orientation defined by the preselected diffractive pattern; and
applying the plurality of diffracted laser beams to particular volume regions of the sample corresponding to the selected diffraction pattern.

24. The method as defined in claim 23 further including the step of sensing light beams received from the particular volume regions of the sample.

25. The method as defined in claim 23, further including the step of establishing a virtual alignment of the plurality of diffracted laser beams.

26. The method as defined in claim 25, wherein the step of establishing a virtual alignment includes the calculation of a phase shifting pattern produced by the diffraction medium.

27. The method as defined in claim 23, further including the step of enabling dynamic change of the particular volume regions being affected by the plurality of diffracted laser beams.

28. A confocal microscope system for examination of a sample, comprising:
a source for a laser beam;
a diffraction medium which interacts with the laser beam to produce a plurality of laser beams;
an optical component to apply the plurality of laser beams to the sample; and
means for detecting light beams scattered from the sample.

29. The confocal microscope as defined in claim 28, further comprising means for establishing an alignment of the plurality of laser beams at positions on the detection means.

30. The confocal microscope as defined in claim 28, wherein the diffraction medium comprises an addressable spatial light modulator, wherein the addressable spatial light modulator enables dynamic change of sample volumes undergoing illumination by the plurality of laser beams.

31. The confocal microscope as defined in claim 30, wherein the addressable spatial light modulator is programmed to cause scanning of a selected region of a sample.

32. The confocal microscope as defined in claim 28, wherein the diffraction medium comprises a reflection-mode spatial light modulator.
